(19) United States
(12) Patent Application Publication
(10) Pub. No.: US 2015/0067312 A1
(43) Pub. Date: Mar. 5, 2015

(54) AUTOMATED POWER CYCLING UNIT OF A DATA PROCESSING DEVICE

(71) Applicants: Jeffrey Lewandowski, Anaheim, CA (US); Travis Brooks, Irvine, CA (US)

(72) Inventors: Jeffrey Lewandowski, Anaheim, CA (US); Travis Brooks, Irvine, CA (US)

(21) Appl. No.: 14/013,034

(22) Filed: Aug. 29, 2013

(51) Int. Cl. G06F 1/26; G06F 9/44

(52) U.S. Cl. CPC G06F 1/26; G06F 9/4401
USPC 713/2; 713/300

(57) ABSTRACT

A method, a system, and a device to provide an automated power cycling operation to a data processing device are disclosed. In one embodiment, a method includes receiving an error signal of a data processing device, through a processor of a power cycle unit, wherein the power cycle unit is coupled to the data processing device. In another embodiment, the power cycle unit may disconnect electrical power from a power supply to the data processing device. For example, the data processing device may require a power cycling operation to improve performance and the power cycle unit may comprise one or more routines for a power cycle operation. The power cycle unit may include a processor to detect computational errors and trigger the power cycling operation. Further, an administration server may be in communication with the power cycle unit and may allow a remote triggering of the power cycling operation.

### FIELD OF TECHNOLOGY

This disclosure relates generally to the technical field of automating a power cycling operation of a data processing device, and in one example embodiment, to a system involving a unit to provide an automated power cycling of the data processing device.

### BACKGROUND

A data processing device (e.g., a personal computer (PC), a network server, and/or a global positioning system (GPS)) may require a power cycling procedure. For example, a processing or computational error may cause the data processing device to freeze (e.g. a process may lock and/or suspend). Or, in an embodiment where the data processing device is in a data communication with another data processing device through a modem and/or network adapter, a processing error of either data processing device may cause data in the data communication to freeze, to be lost, or become out of sync.

Further, a power supply connected to at least one of the data processing devices may need to be disconnected from the data processing device in order to clear bits from the data communication and/or from a temporary memory (e.g., random access memory (RAM)) thereof. In one embodiment, this may require a user of the data processing device to physically remove the power supply. The user may be inconvenienced by this operation. For example, the power supply may be unreachable. Also, the user may not know a proper duration of time required by the data processing device for a complete power cycling event. Therefore, the data processing device may perform poorly and/or may be unable to communicate with other data processing devices.

### SUMMARY

A method, system, and an apparatus related to automating a power cycle operation of a data processing device. In one aspect, a method includes receiving an error signal of a data processing device, through a processor of a power cycle unit, wherein the power cycle unit is coupled to the data processing device. Further, the method also includes triggering a timer circuit of the power cycle unit wherein the processor interprets the error signal and temporarily disables a power supply to the data processing device based on a predetermined duration, said triggering being accomplished through a processer of the data processing device. Furthermore, the method includes rebooting the data processing device, through enabling the power supply, wherein the predetermined duration has elapsed.

According to another aspect, a device includes a processor that is configured to receive an input from a data processing device. The device also includes a relay configured to pass electrical power to the data processing device when closed. Further, the device includes a timer circuit configured to open the relay for a predetermined duration based on the input to the processor, thereby deactivating the data processing device.

In yet another aspect, a system of automated power cycling involves a data processing unit configured to generate an error signal based on a self-detected error thereof. The system also involves a power cycle unit configured to receive an error signal through a processor thereof. The power cycle unit may also be configured to disconnect electrical power to the data processing device based a predetermined duration of time. Further, the system of automated power cycling involves a power supply configured to provide electrical power to at least one of the data processing device and the power cycle unit.

The methods, system, and/or apparatuses disclosed herein may be implemented in any means for achieving various aspects, and may be executed in a form of machine readable medium embodying a set of instruction that, when executed by a machine, causes the machine to perform any of the operation disclosed herein. Other features will be apparent from the accompanying drawing and from the detailed description that follows.

### BRIEF DESCRIPTION OF DRAWINGS

Example embodiments are illustrated by way of example and not limitation in the figures of the accompanying drawing, in which like references indicate similar elements and in which:

FIG. 1 shows a system of an automated power cycling of a GPS unit with a power cycle unit and a power supply, according to one embodiment.

FIG. 2A shows a schematic of the GPS unit and various hardware and software elements thereof, according to one embodiment.

FIG. 2B shows an error detection unit and various hardware and software elements thereof, according to one embodiment.

FIG. 3 displays a schematic of the power cycle unit of FIG. 1 as well as elements that interface through input and output terminals, according to one embodiment.

FIG. 4 displays internal components of a timer unit of the power cycle unit, according to one embodiment.

FIG. 5 is a process flow of an automated power cycling operation, according to one embodiment.

FIG. 6 is a process flow of an automated power cycling operation involving an administration server, according to another embodiment.

Other features of the present embodiments will be apparent from the accompanying drawings and from the detailed description that follows.

### DETAILED DESCRIPTION

Example embodiments, as described below, may be used to provide a method, a system, and/or an apparatus of automatically cycling a power source to a data processing device through a power cycle unit, according to one or more embodiments.

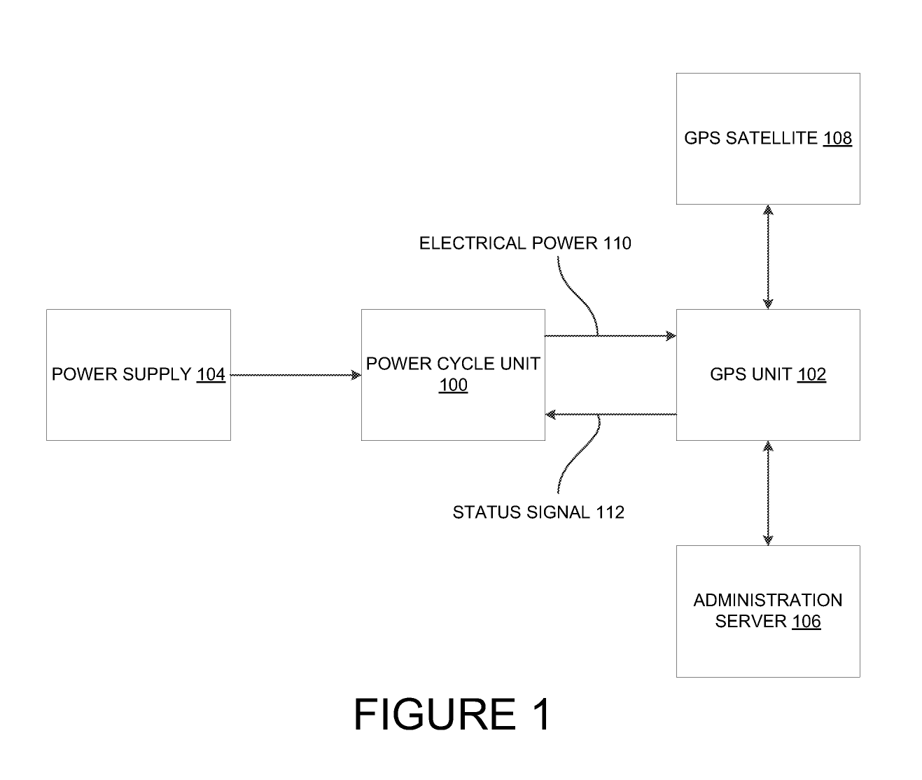

FIG. 1 is a schematic of an automatic power cycling unit coupled to a data processing device, according to one embodiment. In one or more embodiments, a power cycle unit 100 may be connected to a data processing device. According to a particular embodiment of a data processing device, power cycle unit 100 may be connected to a global positioning system (GPS) unit 102. It should be noted however, that the data processing device is not limited to the said embodiment of GPS unit 102 and may be any electronic device that requires power cycling (e.g., cycling power on and off in order to troubleshoot an error).

In one or more embodiments, power cycle unit 100 may be wired to GPS unit 102 in such a way that electrical power from a power supply 104 may pass through an internal wiring of power cycle unit 100 to GPS unit 102. For example, power cycle unit 100 may be in a series connection between power supply 104 and GPS unit 102. According to another embodiment, power cycle unit 100 may include an input/output interface (e.g., input terminals, output terminals, electrical wire harness) to provide electrical power 110 and/or a data communication (e.g., status signal 112) between power supply 104 and GPS unit 102.

According to another embodiment of GPS unit 102 of FIG. 1, a GPS satellite 108 may be in a wireless communication with GPS unit 102, wherein a location data may be communicated to the GPS unit 102. Further, an administration server 106 may be in wireless communication with GPS unit 102, according to one embodiment. For example, GPS unit 102 may be providing geospatial tracking to administration server 106, based on the location data communicated through GPS satellite 108.

Power cycle unit 100 may be in data communication with GPS unit 102, in or more embodiments. For example, GPS unit 102 may communicate status signal 112 (e.g., normal code or reset code) to the power cycle unit 100 based on an operating status (e.g., normal operating mode, loss of communication, memory lock-up). Further, power cycle unit 100 may initiate a procedure to cycle electrical power 110 on and off, based on status signal 112. Power cycle unit 100 may comprise the components (e.g., relays, switches, and/or logic gates) necessary to facilitate the procedure, in one or more embodiments.

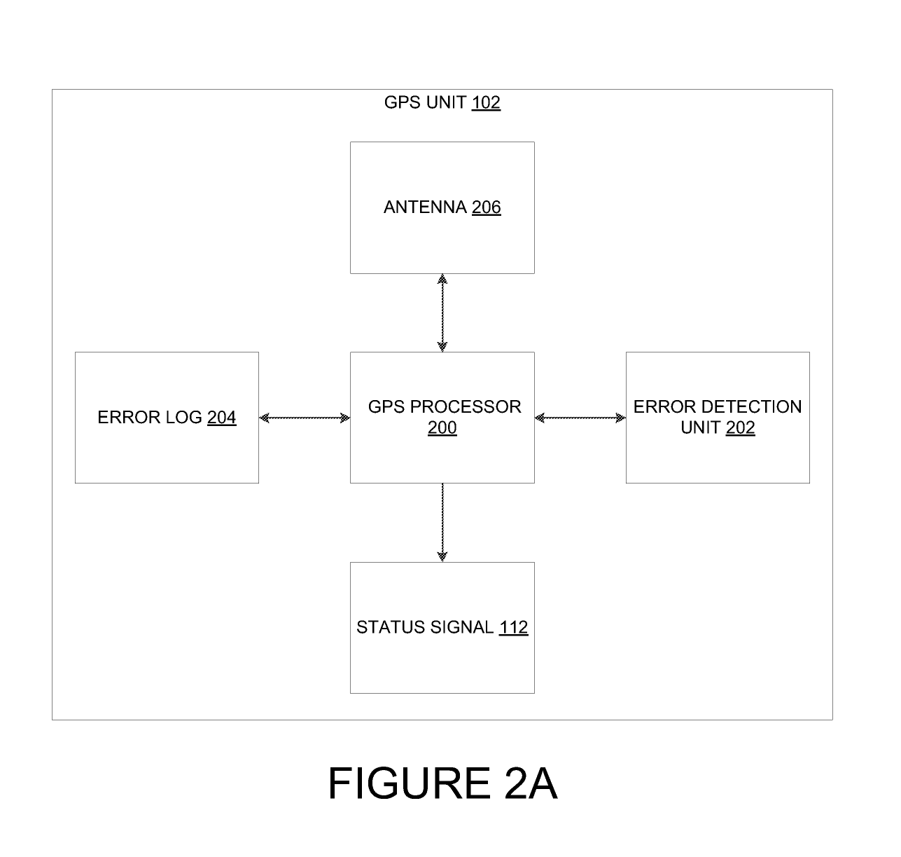

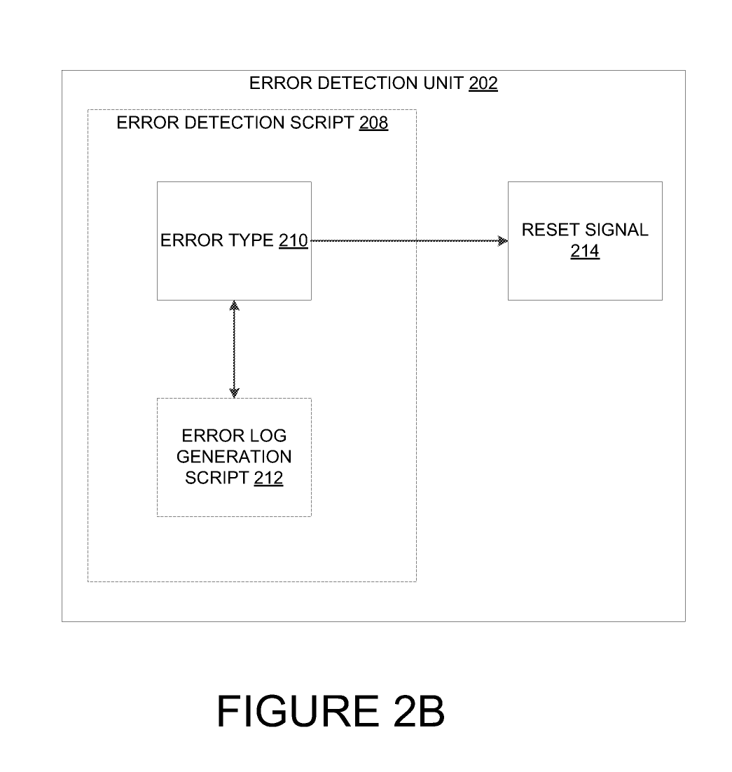

FIG. 2A depicts an embodiment of internal hardware and/or software of GPS unit 102 that may be required to provide automated power cycling thereof. In one or more embodiments, a GPS processor 200 may facilitate data processing operations and/or data communications of GPS unit 102. In another embodiment, GPS unit 102 may include an error detection unit 202. In one or more embodiments, error detection unit 202 may comprise hardware and/or software to enable an automated detection of processing errors thereof. Further, error detection unit 202 may function as a background program of GPS unit 102 and may generate a reset signal via status signal 112 based on detected processing errors and/or data communication errors (e.g., modem lock-up, antenna errors, unable to establish two-way communication with administration server 106 and/or GPS satellite 108).

According to one embodiment, GPS unit may comprise an error log 204 in order to provide information about a detected error to the administration server 106. In one or more embodiments, error log 204 may utilize a temporary non-volatile storage (e.g., Read-Only Memory (ROM), hard-disk storage, etc.) of GPS unit 102, wherein error log 204 may be retrieved by and/or communicated to administration server 106. In one or more embodiments, error log 204 may comprise a type of error, a time that an error occurred, a plurality of operating conditions causing an error, and/or a record of status signal 112 being changed in order to trigger a power cycle. Error log 204 may allow administration server 106 to decrease future occurrences of errors by determining a cause thereof, according to embodiment.

Additionally, GPS unit 102 may include an antenna unit 206 to enable wireless communication with administration server 106, GPS satellite 108, and/or a remote third-party, in one or more embodiments. For example, antenna unit 206 may comprise a GPS receiver that utilizes a communication standard such as National Marine Electronics Association (NMEA) 0183 and/or other various GPS communication protocols in order to bi-directionally communicate with GPS satellite 108, according to one embodiment. Further, antenna unit 206 may comprise a cellular communications antenna and may utilize communication standards such as Code Division Multiple Access (CDMA) and/or Global System for Mobile communications (GSM) in order to communicate bi-directionally with administration server 106 over a wireless network.

FIG. 2B depicts an embodiment of error detection unit 202, wherein various software methods may be utilized to detect errors and provide automated power cycling of GPS unit 102. In one or more embodiments, error detection unit 202 may comprise an executable environment wherein an error log generation script 212 may continuously loop as a background process. According to one embodiment, error log generation script 212 may detect a specific error type 210, according to the error detected thereof. In one or more embodiments, error type 210 may include modem lock-up, antenna failure, and/or GPS processor 200 errors.

In one or more embodiments, error detection script 208 may run an error log generation script 212 based on error type 210. For example, error log generation script 212 may generate a text file comprise details of error and/or failure. According to one embodiment, the text file may comprise error log 204 and may be stored in a temporary non-volatile memory. Further, error detection script 208 may trigger a reset signal 214, wherein status signal 112 comprises reset signal 214 based on error type 210.

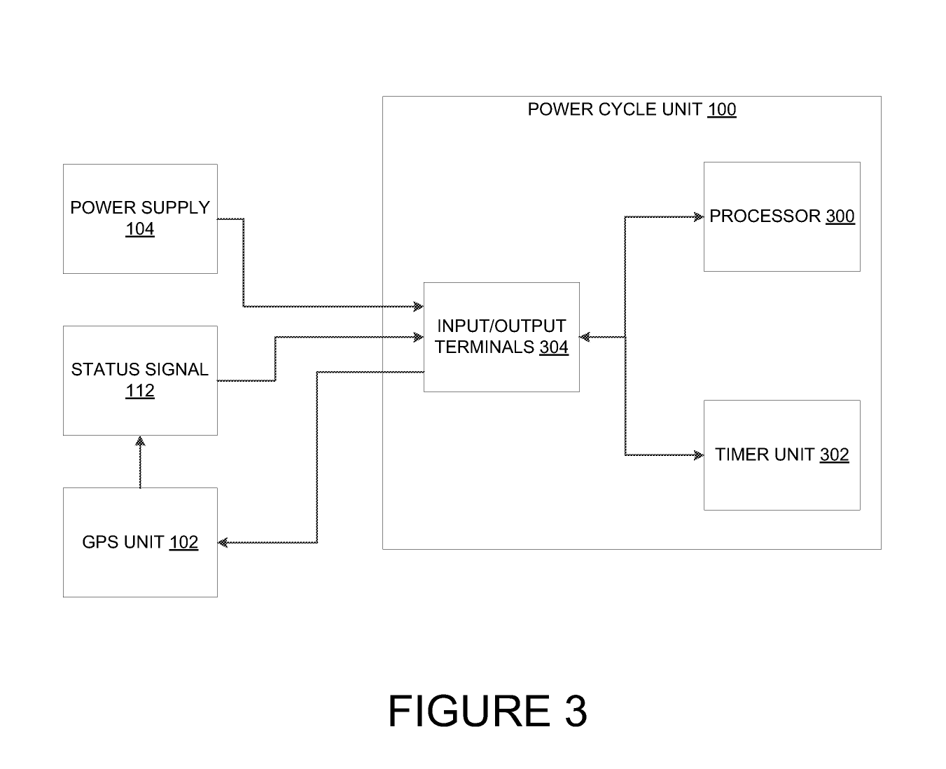

FIG. 3 depicts an exemplary schematic of power cycle unit 100, according to one embodiment. In one or more embodiments, power cycle unit 100 may interface with power supply 104, GPS unit 102, and/or an auxiliary device through input/output terminals 304 (e.g., power and/or data terminals). For example, power supply 104 may deliver +12 volt (V) electrical power to power cycle unit 100 thereby delivering electrical power to GPS unit 102 through input/output terminals 304.

According to another embodiment, power cycle unit 100 may comprise a processor 300. In one or more embodiments, processor 300 may receive status signal 112 as an input from GPS unit 102. For example, processor 300 may interpret status signal 112 to be LOW (e.g., 0 V) and may be configured to allow electrical power from power supply 104 to pass through to GPS unit 102. In one or more embodiments, processor 300 may interpret status signal 112 to be HIGH (e.g., +3.5 V) and may be configured to cycle electrical power to the GPS unit 102 thereafter. Other configurations are evident and are within the scope of this disclosure.

In one or more embodiments, power cycle unit 100 may include a timer unit 302 in order to establish an interval of time to cycle power supply 104 with. For example, timer unit 302 may include a counter and a relay 502 to cycle power supply 104. According to another embodiment, the functionality of timer unit 302 may occur as a function of processor 300. For example, processor 300 may include software with which to configure timer unit 302 and/or may be a programmable integrated circuit.

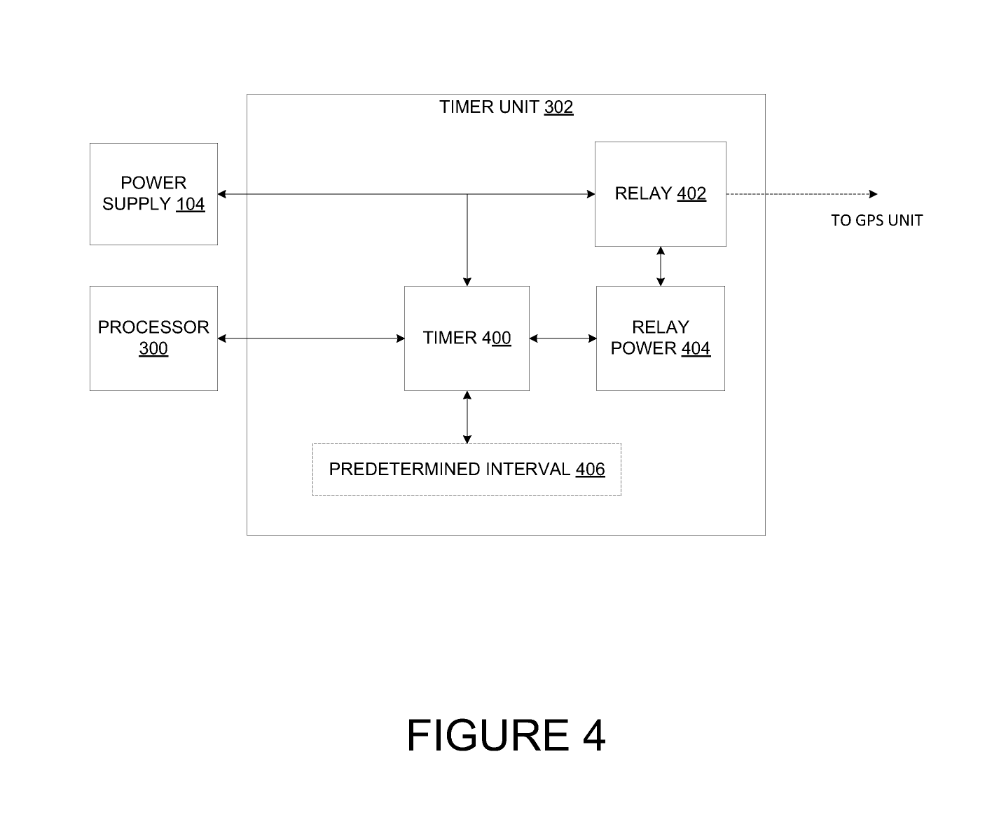

FIG. 4 depicts an exemplary embodiment of timer unit 302, wherein timer unit 302 is configured to provide automated power cycling. In one or more embodiments, timer unit 302 includes a timer 400 to drive a switching of power from an ON to an OFF state. For example, timer 400 may be a programmable timer wherein a duration of time may be configured through a user input. According to another embodiment, timer 400 may be configured by a manufacturer to include a predetermined interval 406, according to power cycling specifications of a specific data processing device (e.g. GPS unit 102).

In one or more embodiments, timer 400 may count down based on predetermined interval 406 and initiate a switching action at the expiration of predetermined interval 406. For example, power supply 104 may be wired to relay 402, wherein relay 402 may provide the switching action. In one or more embodiments, processor 300 may provide a trigger input to timer 400 therein starting a countdown. As a result, electrical power from the power supply may be supplied to relay power 404 (e.g., relay coil) for the duration of the countdown. Further, when electrical power is supplied to relay power 404, relay 402 may open and/or switch so that electrical power to GPS unit 102 is cut off. Furthermore, relay 402 may remain open and/or switched until predetermined interval 406 expires, wherein relay power 404 may be cut off, causing relay 402 to close and/or switch to its original position. Electrical power to GPS unit 102 may be supplied thereafter, according to one embodiment.

Timer unit 302 of FIG. 3 and FIG. 4 is an important element of automated power cycling, according to one embodiment. For example, timer unit 302 may receive an automated input wherein relay 402 is powered for a duration of time and power supply 104 is disconnected from GPS unit 102. Accordingly, the duration of time wherein power supply 104 is disconnected may provide an amount of time needed to properly power cycle the data processing device. For example, GPS unit 102 may have cleared bits from RAM and/or may be able to boot-up cleanly upon a proper power cycle procedure.

In one or more embodiments, timer unit 302 may be a programmable logic controller (PLC), wherein timer 400 may be built-in and configurable through a software interface. In another embodiment, timer unit 302 may include an integrated circuit such as a 555 timer, wherein multiple modes of timing may be available. According to another embodiment, timer unit 302 may utilize a quartz clock and a counter as timer 400. Timer unit may include various logic statements configured to cycle power ON and OFF based on a number of the counter. In an additional embodiment, relay 402 may be normally closed (i.e., connecting power supply 104 to GPS unit 102).

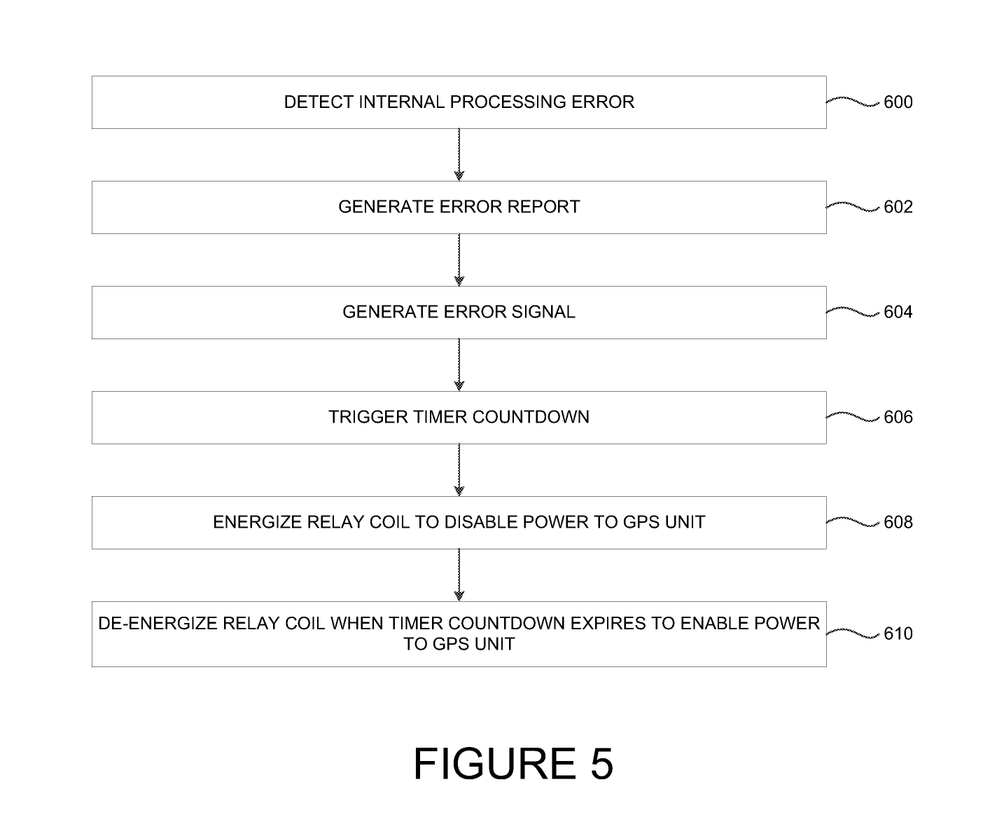

FIG. 5 is a process flow of an embodiment where an error thereof GPS unit 102 triggers power cycling. In operation 500, GPS unit 102 may detect an internal processing error thereof. For example, processor 300 may determine that a modem thereof GPS unit 102 has lost communication with administration server 106. In operation 502, error detection unit 202 may generate an error report that may be analyzed at a later time by administration server 106 whereupon communication is reestablished. In operation 504, processor 300 may generate an error signal to power cycle unit 100 (e.g., status signal 112).

In operation 506, error signal may trigger a timer countdown therethrough timer unit 302, in one or more embodiments. In operation 508, power cycle unit 100 may energize a relay coil (e.g., relay power 404) of timer unit 302. According to one embodiment, supplying electrical power to the relay coil may actuate/open a switch thereby suspending electrical power to GPS unit 102. In operation 510, power cycle unit 100 may de-energize the relay coil when the timer countdown expires. According to one embodiment, the relay may close thereafter electrical power is suspended to the coil, thereby connecting power supply 104 to GPS unit 102.

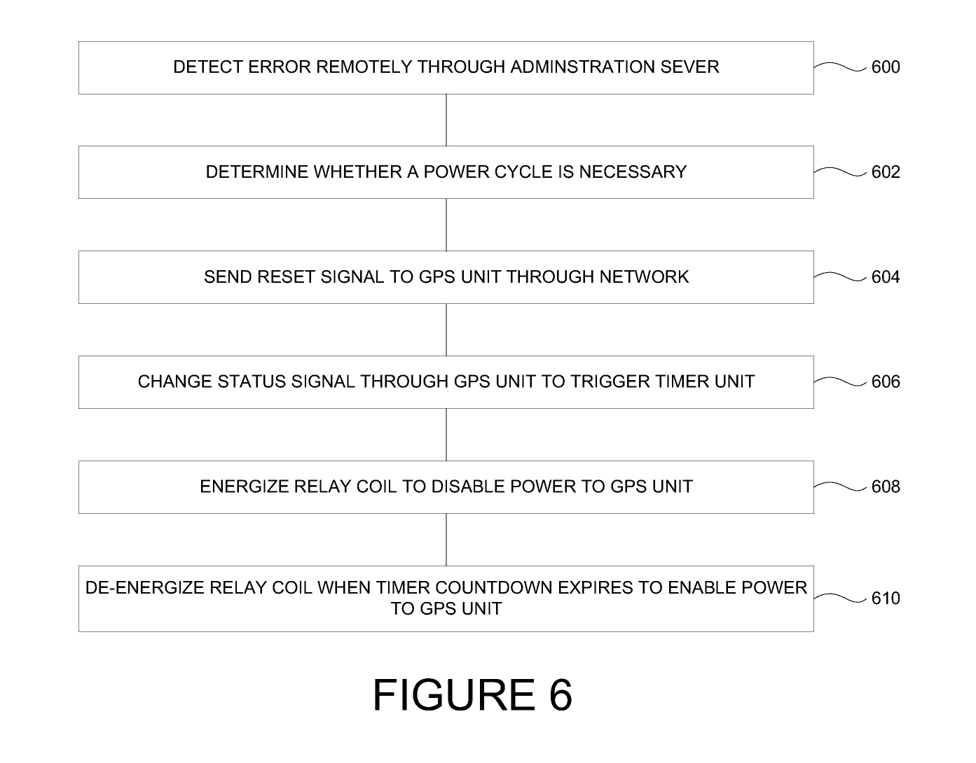

FIG. 6 is a process flow of error reporting, according to one embodiment. In operation 600, administration server 106 may remotely detect an error of the GPS unit 102 through a wireless communication. In operation 602, administration server 106 may determine whether a power cycle operation is required in order for GPS unit 102 to function correctly. In operation 604, administration server 106 may send a reset signal. For example, the reset signal may change status signal 112 through GPS unit 102, according to operation 606. Further, timer 400 may be triggered and a countdown may begin. In operation 608, a relay coil may be energized to disconnect power from power supply 104 to GPS unit 102. Furthermore, in operation 610, the relay coil may be de-energized wherein the countdown expires, thereby restoring power to GPS unit 102.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and/or software (e.g., embodied in a machine readable medium). For example, the various electrical structure and methods may be embodied using transistors, logic gates, and/or electrical circuits (e.g., application specific integrated (ASIC) circuitry and/or Digital Signal Processor (DSP) circuitry).

In addition, it will be appreciated that the various operations, processes, and/or methods disclosed herein may be embodied in a machine-readable medium and/or a machine accessible medium compatible with a data processing system (e.g., a computer device). Accordingly, the specification and drawings are to be regarded in an illustrative in rather than a restrictive sense.

What is claimed is:

1. A method comprising:
receiving an error signal of a data processing device, through a processor of a power cycle unit, wherein the power cycle unit is coupled to the data processing device;
triggering a timer circuit of the power cycle unit, by the processor, wherein the processor interprets the error signal and temporarily disables a power supply to the data processing device based on a predetermined duration; and
rebooting the data processing device, through enabling the power supply, wherein the predetermined duration has elapsed.

2. The method of claim 1, further comprising:
placing the power cycle unit between the power supply to the data processing device therethrough a closed contactor;
opening, through the timer circuit, the closed contactor to disable the power supply to the data processing device; and
powering, through the power supply, the power cycle unit.

3. The method of claim 1, wherein the data processing device further comprises:
receiving, through a global positioning system (GPS) satellite, location data associated with a physical location of the data processing device; and
communicating, through a wireless network, the location data to an administrative server.

4. The method of claim 1, further comprising:
automatically generating the error signal based on at least one of an internal processing error, a modem error, a command by the administrative server, and a user command.

5. The method of claim 1, wherein the predetermined duration is based on at least one of a known duration required to successfully power cycle the data processing device and a manual configuration through at least one of a user interface of the data processing device and the administrative server.

6. The method of claim 1, further comprising:
enclosing the power cycle unit, through an enclosure of the data processing device, wherein the power cycle unit is connected in series between the power supply and the data processing device.

7. The method of claim 1, further comprising:
communicating, through the processor and the wireless network, an error report to the administrative server, wherein the error report comprises a plurality of conditions of the data processing device related to the error signal.

8. A power cycle unit comprising:
a processor configured to receive an input from a data processing device;
a relay configured to pass electrical power to the data processing device when closed; and
a timer circuit configured to open the relay for a predetermined duration based on the input to the processor, thereby deactivating the data processing device.

9. The timer circuit of claim 8, wherein the predetermined duration is based on at least one of a known duration required to successfully power cycle the data processing device and a manual configuration through at least one of a user interface of the data processing device and the administrative server.

10. The relay of claim 8, wherein the relay closes when the predetermined duration elapses, thereby initiating a reboot of the data processing device.

11. The power cycle unit of claim 8, wherein the input from the data processing device is automatically generated and is based on at least one of an internal processing error, a modem error, a command by the administrative server, and a user command.

12. The power cycle unit of claim 8, wherein the power cycle unit is enclosed within the data processing device and the relay is connected in series between a power supply and the data processing device.

13. The power cycle unit of claim 8, wherein the processor is powered through the power supply to the data processing device.

14. A system comprising:
a data processing unit configured to generate an error signal based on a self-detected error thereof;
a power cycle unit configured to receive an error signal through a processor thereof and to disconnect electrical power to the data processing device based a predetermined duration; and
a power supply configured to provide electrical power to at least one of the data processing device and the power cycle unit.

15. The power cycle unit of claim 14, wherein a relay thereof disconnects electrical power to the data processing device by opening a contactor.

16. The power cycle unit of claim 14, wherein the relay remains open throughout the predetermined duration by at least one of an internal timer of the processor and a timer circuit that is configured to open the relay based on an input from the processor.

17. The data processing device of claim 14, wherein the data processing device is configured to initiate a reboot procedure based on the predetermined duration elapsing, thereby closing the relay and restoring electrical power to the data processing device.

18. The data processing device of claim 14, wherein the data processing device is configured to automatically generate the error signal to the power cycle unit based on at least one of an internal processing error, a modem error, a command by the administrative server, and a user command.

19. The data processing device of claim 14, wherein the predetermined duration is based on at least one of a known duration required to successfully power cycle the data processing device and a manual configuration through at least one of a user interface of the data processing device and the administrative server.

20. The data processing device of claim 14, wherein the data processing is configured to communicate an error report to the administrative server based on the reboot procedure, wherein the error report comprises a plurality of operating conditions of the data processing device associated with the error signal.
